(19) United States
(12) Patent Application Publication
(10) Pub. No.: US 2026/0299275 A1
(43) Pub. Date: Oct. 1, 2026

(54) Microscope and Microscopy Method

(71) Applicant: Carl Zeiss Microscopy GmbH, Jena (DE)

(72) Inventors: Eva Simbuerger, Schwielowsee (DE); Lars Loetgering, Jena (DE)

(21) Appl. No.: 19/577,650

(22) Filed: Mar. 25, 2026

(30) Foreign Application Priority Data
Mar. 26, 2025 (DE) 10 2025 111 659.8

(51) Int. Cl. G02B 21/08; G01N 21/01; G01N 21/64; G02B 21/02; G02B 21/36

(52) U.S. Cl. CPC G02B 21/082; G01N 21/01; G01N 21/6458; G02B 21/02; G02B 21/365; G01N 2021/6463

(57) ABSTRACT

The invention relates to a microscope having an illumination beam path with a radiation source for emitting excitation light, having a detection beam path with a microscope objective and with a detector for detecting emission light emitted by a sample in the sample region as a consequence of being irradiated by the excitation light and having a control unit for evaluating the emission light detected by the detector. The control unit is configured to make use of the original excitation spectra and emission spectra of those dyes with which the sample is prepared, and spectral properties of the illumination beam path and of the detection beam path to ascertain values proportional to concentrations of the respective dyes at a location in the sample from measurement data measured by the detector for the relevant location in the sample for different system configurations. The invention also relates to a microscopy method.

The current application claims the benefit of German Patent Application No. 10 2025 111 659.8, filed on 26 Mar. 2025, which is hereby incorporated by reference.

The invention relates in a first aspect to a microscope according to the preamble of Claim 1 and in a further aspect to a microscopy method according to the preamble of Claim 6.

A generic microscope comprises the following components: an illumination beam path with a radiation source for emitting excitation light, the illumination beam path being configured to guide the excitation light into a sample region, a detection beam path with a microscope objective and with a detector for detecting emission light emitted by a sample in the sample region as a consequence of being irradiated by the excitation light, the detection beam path being configured to guide the emission light to the detector, and a control unit for evaluating the emission light detected by the detector, the control unit having a memory device in which original excitation spectra and emission spectra of dyes and, for different system configurations of the illumination beam path and of the detection beam path, spectral properties of the illumination beam path and spectral properties of the detection beam path are stored.

In a generic method, the following method steps are carried out: a) excitation light emitted by a radiation source is guided into a sample region via an illumination beam path, b) emission light emitted by a sample in the sample region as a consequence of being irradiated by the excitation light is guided to a detector via a detection beam path comprising a microscope objective, and c) the emission light for different locations in the sample is measured by the detector in each case for different system configurations of the illumination beam path and of the detection beam path.

Numerous configurations of such microscopes and such methods are known.

In microscopy, it has now become standard practice to use three or more markers of different colour that each label specific parts of the sample in colour, for example a structural protein, DNA sequences, a cell membrane, or cellular compartments, and to analyse them within a single experiment. In this application, the markers of different colour are also referred to as dye markers, fluorophores or dyes. In particular, the dyes may be fluorescent dyes. An exact distinction between the dyes is necessary in order to be able to localize the parts of the sample labelled therewith, i.e. the molecules labelled therewith, unambiguously in the cell or tissue examined. The samples may also comprise fluorescent proteins, in particular in combination with fluorescent dyes. On account of the large number of different dyes used in the same experiment and since the emission spectra are sometimes very broad and mostly overlap as well, it is often no longer possible to separate the dyes from one another solely by hardware-based filtering techniques. It is thus no longer possible to distinguish between the dyes. In this case, the image data are processed with the aid of the individual emission spectra, i.e. reference spectra, and molecules which are each marked with the same dye can thus be represented in one image channel in each case.

For such methods, which are also referred to as spectral unmixing or linear unmixing, information about the emission spectra to be expected in the sample is required. In the microscope itself, the emission spectra are now distorted by the spectral properties of the optical components used, for example light sources, filters, glasses, prisms, grating and detectors. At the location of the respective dyes in the sample of the microscope, it is therefore no longer the respective original emission spectra that are effective but emission spectra modified by a spectral signature of the optical system. This spectral signature is unique for each system, and the user has no choice but to image individual emission spectra and determine the spectral signature from these images in each case. The complexity of this approach varies depending on the availability of the original emission spectra. If the emission spectra are spatially separated, for example laterally separated, from one another in a sample, then the emission spectra can be ascertained from a sample with the aid of the number of emission spectra to be expected. If the emission spectra are not spatially separated from one another in a sample, it is necessary to produce individual preparations from which a spectral signature of the emission spectrum can be determined in each case. The production of such preparations, which each have a dye, is time-consuming and, in addition, harbours the risk that the preparation, which is different every time, has an effect on the subsequently measured spectral signature.

In addition, the acquisition settings for the measurement of the spectral signatures from the preparations may differ from the acquisition settings for the sample, which is subsequently actually examined and marked with a plurality of dyes, and these differences, for example different high voltages of the detectors, different spectral ranges for the detection or else different illuminance values, may have a negative effect on the result during the unmixing. Although these methods are generally lengthier in preparation, they lead to better unmixing results.

Alternatively, the nominal or original emission spectra can also be used; however, this may lead to less reliable results because the influences of the spectral properties of the hardware are not taken into account in this case. This can lead to emission signals being assigned to incorrect image channels and hence to an incorrect test result. As the number of simultaneously used dyes increases, the accuracy of the spectral signatures used for unmixing becomes ever more important. These methods are significantly faster because the prior generation of reference spectra is omitted; however, they have limited applicability on account of the above-described limitations and may also give incorrect results, depending on the sample and number of dyes.

Finally, it is also known practice to use the emission spectra of markers of different colours to set the microscope system hardware such that the dyes used in each case can be excited and imaged. To this end, the specified, system-specific hardware components are set such that e.g. the best possible representation of multiple dyes or the fastest possible representation of multiple dyes is possible to the best possible extent, in accordance with user specifications. In these methods, the components of the crosstalk of emission signals into other image channels can be ascertained from the spectral properties of the set hardware and can be displayed.

A problem addressed by the invention can be regarded as that of providing a microscope and a microscopy method with which particularly accurate microscopy results can be provided for samples that were prepared using many different dyes with overlapping excitation and/or emission spectra.

This problem is solved by the microscope having the features of Claim 1 and the method having the features of Claim 6.

According to the invention, the microscope of the aforementioned type is developed in that the control unit is configured to make use of the original excitation spectra and emission spectra of those dyes with which the sample is prepared, the spectral properties of the illumination beam path and the spectral properties of the detection beam path to ascertain values proportional to concentrations of the respective dyes at a location in the sample from measurement data measured by the detector for the relevant location in the sample for different system configurations.

According to the invention, the method of the aforementioned type is developed in that using original excitation spectra and emission spectra of dyes with which the sample is prepared and using spectral properties of the illumination beam path and spectral properties of the detection beam path in the respective different system configurations, values proportional to concentrations of the respective dyes at a location in the sample are ascertained from measurement data measured by the detector for the relevant location in the sample in the different system configurations.

Advantageous exemplary embodiments of the microscope according to the invention and preferred variants of the method according to the invention will be explained below, in particular in connection with the dependent claims and the figures.

The microscope according to the invention and, in particular, the control unit of the microscope can preferably be configured to carry out one of the variants of the method according to the invention described here.

The variants of the method according to the invention described here can be carried out using the microscope according to the invention.

The term illumination beam path comprises the radiation source and all, in particular optical, beam-guiding and beam-modifying components, e.g. lenses, mirrors, prisms, gratings, filters, stops, beam splitters, by means of which and via which the excitation light is guided from a radiation source, in particular a light source, to the sample to be examined. The illumination beam path can comprise an illumination objective. The illumination objective and a microscope objective can each be microscope objectives of a type known per se. In principle, the illumination objective and the microscope objective can also be separate objectives. However, in preferred embodiments, the illumination objective and the microscope objective are one and the same objective.

The excitation light is electromagnetic radiation, in particular in the visible spectral range and in adjoining ranges. Thus, the excitation light can also include wavelengths in the UV and infrared range and, for example, wavelengths of up to 1700 nm and longer. The excitation light can also be referred to as illumination light; these two terms are used synonymously for the most part in this description. The radiation source can be any light source capable of supplying the excitation light with a desired wavelength or desired wavelengths and with a suitable intensity. For example, the light source might be a laser, a plurality of lasers, an LED, an LED module or a combination of these components. The excitation light can be coherent light, at least partially coherent light or non-coherent light.

The term sample space denotes the spatial region in which a sample to be examined can be arranged. In typical embodiments, a sample, e.g. by means of a sample holder or a sample frame, can be positioned or secured on an xy-stage which is adjustable in lateral directions with respect to an optical axis. A z-drive can be present to change the distance between the sample stage and the illumination objective or between the sample and the microscope objective.

In principle, the sample can be any kind of sample. The microscope according to the invention and the method according to the invention are suitable for examining biological samples in particular.

Light emitted by the sample to be examined as a consequence of the irradiation by the illumination or excitation light is referred to as emission radiation or else emission light and reaches the detector, e.g. a camera, via the detection beam path. In order for the light to be able to be referred to as emission light, it is only necessary that the light is emitted by the illuminated sample or that in any case it comes from the illuminated sample. Typically, the emission light can be fluorescence, which is radiated or emitted by the sample, in particular dye molecules present there, as a consequence of the irradiation by the excitation light. The emission light can also be reflected, transmitted and scattered illumination light. The only requirement made in respect of the contrast-imparting principle is that the sample emits emission light as a consequence of the irradiation by the excitation light. The sample can also be referred to as a specimen.

The emission light reaches the detector, e.g. a camera, via the detection beam path. Here, the term detection beam path denotes the detector and all beam-guiding and beam-modifying, in particular optical, components, e.g. lenses, mirrors, prisms, gratings, filters, stops, beam splitters, by means of which and via which the emission radiation is guided from the sample to be examined as far as the detector. Expediently, a sensor plane of the detector can be arranged in a plane which is optically conjugate to a focal plane of the microscope objective.

The type of detector used to detect the emission radiation generally depends on the type of microscope. In embodiments of the invention, the detector may be formed from a plurality of individual detectors. For example, the detector may comprise a two-dimensionally spatially resolving photodetector, e.g. one or more cameras, a one-dimensionally spatially resolving detector, e.g. a linear detector arrangement, or a single photodetector, e.g. a point-type photodetector. Specifically, the detector can comprise at least one of the following elements or one of the following components: CCD element, CMOS element, SPAD element, PMT.

The illumination beam path and, optionally, the detection beam path as well may comprise a one-dimensional or two-dimensional scanning device.

The term control unit is understood to mean all hardware and software components that interact with the components of the optical device according to the invention for the intended functionality of the latter. In particular, the control unit can comprise a computing device, for example a PC, and a camera controller capable of reading out measurement signals. Measurement data of the detector are the measurement data generated by the detector upon the irradiation by emission light. The memory device may be a memory device of a known type.

The original, nominal, initial or undisturbed excitation spectrum of a dye refers to that excitation spectrum which the dye has intrinsically, i.e. without being influenced by an optical setup and/or an environment in a sample. The original, nominal, initial or undisturbed emission spectrum of a dye refers to that emission spectrum which the dye has intrinsically, i.e. without being influenced by an optical setup and/or an environment in a sample. In particular, the dyes may be fluorescent dyes.

The term system configuration of the illumination beam path and of the detection beam path denotes the configuration of the spectrally effective optical components in the illumination and detection beam paths.

A transmissive optical component is regarded as spectrally effective if the transmission spectrum in the relevant wavelength range has values of less than 1. Accordingly, a reflective optical component is regarded as spectrally effective if the reflection spectrum in the relevant wavelength range has values of less than 1.

The term spectral properties of the illumination beam path denotes the spectral properties of all spectrally effective optical components in the illumination beam path.

In a preferred exemplary embodiment of the microscope according to the invention, the spectral properties of the illumination beam path include at least the spectral properties of the light source. Preferably, the spectral properties of the illumination beam path additionally contain the spectral properties of at least one of the following components: excitation filters, lenses, mirrors, beam splitters, main beam splitters, microscope objective.

The spectral properties of the illumination beam path may also be referred to as the spectral signature of the illumination beam path. In particular, this spectral signature may be a scalar function of the wavelength of the excitation light in the illumination beam path, which is given by the product of an emission spectrum of the light source, the transmission spectra of transmissive optical components such as filters, microscope objective and lenses, and, if present, the reflection spectra of reflective optical components such as mirrors or beam splitters, in each case in a specific system configuration.

The term spectral properties of the detection beam path denotes the spectral properties of all spectrally effective optical elements in the detection beam path.

In a preferred exemplary embodiment of the microscope according to the invention, the spectral properties of the detection beam path include at least the spectral properties of the detector and of the microscope objective. Preferably, the spectral properties of the detection beam path additionally contain the spectral properties of at least one of the following components: beam splitters, main beam splitters, lenses, mirrors, emission filters, dispersive device in the detection beam path.

The spectral properties of the detection beam path may also be referred to as the spectral signature of the detection beam path. In particular, this spectral signature may be a scalar function of the wavelength of the emission light in the detection beam path, which is given by the product of the transmission spectra of transmissive optical components such as filters, microscope objective and lenses, and, if present, the reflection spectra of reflective optical components such as mirrors and beam splitters, and a spectral detection sensitivity of the detector, in each case in a specific system configuration.

For example, the microscope can realize the function of at least one of the following microscopes: digital microscope, fluorescence microscope, light microscope, transmitted light microscope, reflected light microscope, wide-field microscope, scanning microscope, confocal microscope, light field microscope, light sheet microscope, TIRF microscope, SIM microscope.

For the purpose of unmixing the measurement data and consequently for assigning the individual measurement results to specific dyes, an essential concept of the invention can be regarded as that of taking into account the spectrally effective optical configurations actually present in the utilized microscope when collecting the measurement data.

Since the required information in respect of the original excitation spectra and emission spectra and in respect of the optical data of the optical components used in each case is usually available anyway or known in any case, a significant improvement in the evaluation and hence in the microscopic images can be achieved with comparatively little outlay. In some cases, the invention also allows a greater number of dyes to be used simultaneously.

Variants and examples of spectrally relevant components in the illumination and detection beam paths, by means of which different system configurations can be provided for the measurements, are described below.

In a preferred exemplary embodiment of the microscope according to the invention, the illumination beam path contains a changeover mechanism having a plurality of excitation filters, wherein the individual excitation filters each have different spectral properties and wherein one of the excitation filters can be introduced into the illumination beam path in each case by means of the changeover mechanism.

In a further preferred exemplary embodiment of the microscope according to the invention, a changeover mechanism having a plurality of main beam splitters is present, wherein the individual main beam splitters each have different spectral properties and wherein one of the main beam splitters can be introduced into the illumination and detection beam path in each case by means of the changeover mechanism.

In a further preferred exemplary embodiment of the microscope according to the invention, a changeover mechanism having a plurality of emission filters is present, wherein the individual emission filters each have different spectral properties and wherein one of the emission filters can be introduced into the detection beam path in each case by means of the changeover mechanism.

A main beam splitter which is part of both the illumination beam path and the detection beam path and optionally an excitation filter which is part of the illumination beam path and/or an emission filter which is part of the detection beam path may be accommodated in a filter cube.

Advantageously, a changeover mechanism having a plurality of filter cubes may be present, wherein each filter cube comprises at least one main beam splitter and optionally an excitation filter and/or an emission filter, wherein the different filter cubes each have different spectral properties and wherein one of the filter cubes can be introduced into the illumination and detection beam path in each case by means of the changeover mechanism.

In a further preferred exemplary embodiment of the microscope according to the invention, the detection beam path comprises one or more colour splitters for splitting the emission light into at least two spectrally different channels. A changeover mechanism may also be present, by means of which one colour splitter or a selection of the colour splitters can be introduced into the detection beam path.

At least one component selected from the changeover mechanism for the excitation filters, changeover mechanism for the emission filters, changeover mechanism for the main beam splitters, changeover mechanism for the filter cubes and changeover mechanism for colour splitters in the detection beam path may be formed by a filter wheel or by a linear filter slider.

At least one of the components selected from the changeover mechanism for the excitation filters, changeover mechanism for the emission filters, changeover mechanism for the main beam splitters, changeover mechanism for the filter cubes and changeover mechanism for colour splitters in the detection beam path may be driveable and controllable by a motor.

In a further preferred exemplary embodiment of the microscope according to the invention, the detection beam path comprises a detection unit with the detector and a dispersive device. The dispersive device may comprise an adjustable component, in particular a component that is driveable and controllable by a motor, for setting a range of the wavelengths of emission light that propagate up to the detector. The adjustable component may comprise a spatially displaceable slot, in particular with an adjustable width. A range of the emission of light set for the detection may for example be a sub-range from approximately 400 nm to 1000 nm. The dispersive device may comprise a refractive and/or a diffractive element, for example a prism or a grating. For example, a slot arranged between a grating and the detector may be positioned variably relative to the spectrally and spatially separated detection light by means of a motor and set in terms of its width. Instead of a slot, use can also be made of what are known as partial stops, which are displaceable and adjustable from only one side of the spectrum in each case.

In a preferred variant of the method according to the invention, the original excitation spectra and/or the original emission spectra of at least one of the dyes are determined in advance by ex situ measurements. In an alternative to that, or in addition, the original excitation spectra and/or the original emission spectra of at least one of the dyes are loaded from a database.

The measured measurement data dₖ(x, y, z) with k=1, . . . , K can be written as a vector \vec{d}, the components of which contain the measurement data measured by the detector for a location (x, y, z) in the sample in the k-th system configuration. The number K of components in this vector corresponds to the number of different system configurations in which measurements are carried out. The sought values cₗ(x, y, z) with l=1, . . . , L in turn represent a vector \vec{c}, the components of which represent the colour channels corresponding to the individual dyes. The number L of components in this vector corresponds to the number of different dyes used. Exemplary embodiments of how the sought vector \vec{c} can be ascertained specifically from a mixing matrix will be described below. In the general case, the broadband emissions of the dyes and the spectral properties of the optical system lead to a combination, and consequently to spectral mixing, of the measured signals on the detector, as described at the outset. The assumption can be made that spectral mixing represents a linear process. The relationship between firstly the values cₗ which are sought and to be reconstructed and secondly the measured data dₖ can in that case be written as

$${d}_{k} ( x , y , z ) = {\sum }_{l} {M}_{k , l} {c}_{l} ( x , y , z )$$

where the spatial dependence has been omitted for the sake of clarity and M_{k,l} is a mixing matrix. The mixing matrix M_{k,l} describes the amount of crosstalk between the measured channels.

In a particularly preferred variant of the method according to the invention, the mixing matrix M_{k,l} is calculated as

$${M}_{k , l} = \int {A}_{k} ( {λ}_{1} ) \cdot {χ}_{l} ( {λ}_{1} ) d {λ}_{1} \cdot \int {D}_{k} ( {λ}_{2} ) \cdot {ϵ}_{l} ( {λ}_{2} ) d {λ}_{2} \qquad ( 1 )$$

where
k is the index that denotes the system configurations with which measurements were made,
l is the index that denotes the various dyes,
Aₖ(λ₁) represents the spectral properties of the illumination beam path in the k-th system configuration,
λ₁ is the wavelength of the excitation light in the excitation beam path,
χₗ(λ₁) is the original excitation spectrum of the l-th dye,
Dₖ(λ₂) represents the spectral properties of the detection beam path in the k-th system configuration,
λ₂ is the wavelength of the emission light in the detection beam path and
ϵₗ(λ₂) is the original excitation spectrum of the l-th dye,
and the values cₗ(x, y, z) in each case proportional to the concentration of the various dyes
l at the location (x, y, z) in the sample and consequently the vector c are then ascertained using the mixing matrix M_{k,l}.

The variable Aₖ(λₗ) can be regarded as the above-described spectral signature of the illumination beam path. The variable Dₖ(λ₂) can be regarded as the above-described spectral signature of the detection beam path.

Since the mixing matrix M_{k,l} only depends on variables that are independent of the sample itself, the mixing matrix M_{k,l} calculated according to Equation (1) is also referred to as digital mixing matrix.

In a first advantageous variant, the following system of equations is solved in order to ascertain the sought values cₗ(x, y, z), which are each proportional to the concentration of the various dyes l at the location (x, y, z) in the sample:

$${d}_{k} ( x , y , z ) = {\sum }_{l} {M}_{k , l} {c}_{l} ( x , y , z ) \qquad ( 2 )$$

(where k=1, . . . , K). Here, dₖ(x, y, z) is the vector which contains the measurement data measured by the detector for a location (x, y, z) in the sample for the k-th system configuration as components. The system of equations (2) can be solved, and consequently linear spectral unmixing is possible, if there are at least as many independent measurements available as unknown fluorescence channels are present, i.e. if K≥L. This is referred to as linear spectral unmixing.

Omitting the spatial dependencies and the indices, the system of equations (2) can be written in vector form:

$$\vec{d} = M \vec{c} \qquad ( 2 )$$

By preference, the number K of different system configurations k in which measurements are carried out is greater than or equal to the number L of different dyes l. In that case, \vec{d}=M\vec{c} provides an overdetermined system of equations. Taking account of the noise properties, it is possible in that case to use different methods of solving overdetermined linear systems of equations.

Advantageously, a Moore-Penrose inverse M^{MP} of the mixing matrix M is calculated as

$${M}^{MP} = {( {M}^{T} M + δ I )}^{- 1} {M}^{T}$$

where M^{T} is the transpose of the matrix M, I is the unit matrix, δ is a scalar regularization parameter and (M^{T}M+δI)⁻¹ is the inverse matrix of M^{T}M+δI. Using the Moore-Penrose inverse M^{MP}, the sought vector c can then be calculated as \vec{c}=M^{MP}\vec{d}.

If the number K of different system configurations k in which measurements are carried out is greater than or equal to the number L of different dyes l, then there is no need for a regularization, i.e. the regularization parameter δ can be set to zero.

The solution ascertained using the Moore-Penrose inverse applies if substantially Gaussian-distributed noise is present. If Poisson noise is assumed instead, it is possible to use an iterative algorithm in order to unmix the fluorescence signals. In this case, c is determined iteratively, wherein the n+1-th value \vec{c}ₙ₊₁ is in each case calculated from the n-th value \vec{c}ₙ by

$${\vec{c}}_{n + 1} = ( [ {\vec{c}}_{n} ] / [ {M}^{T} \cdot 1 ] ) ∘ ( {M}^{T} ( [ \vec{d} ] / [ M \cdot {\vec{c}}_{n} ] ) ) ,$$

where
M^{T} is the transpose of the matrix M,
1 is a vector whose components all have the value of 1,
the square brackets each denote element-by-element division and
⋅ denotes element-by-element multiplication.
   Spatial dependencies were omitted yet again in this case.

For example, the solution \vec{c}=M^{MP}\vec{d} calculated using the Moore-Penrose inverse can be used as initial value \vec{c}₀, wherein the regularization parameter δ can be set to zero in the process.

If the number K of different system configurations k in which measurements are carried out is less than the number L of the different dyes l, then it is possible to use regularization techniques and a priori knowledge. For example, should it be known that the colour channels to be reconstructed are sparse, then it is possible to use inversion techniques which reconstruct a solution with the latter property (sparsity).

Consequently, in a preferred variant of the method according to the invention, the values proportional to the concentrations of the respective dyes at a location in the sample are ascertained under the assumption that values of the colour channels are very unequal everywhere. This assumption is tantamount to the assumption that given any pixel, any potential intensity present is substantially present in only one of the colour channels.

For example, \vec{c} can be determined iteratively, wherein the n+1-th value \vec{c}ₙ₊₁ is in each case calculated from the n-th value \vec{c}ₙ by

$${\vec{c}}_{n + 1} = sign ( {\vec{e}}_{n + 1} ) \cdot max ( \vert {\vec{e}}_{n + 1} \vert - μ , 0 ) , \qquad ( 3 )$$

$$where$$

$${\vec{e}}_{n + 1} = {\vec{e}}_{n} - {s}_{n} \cdot {M}^{T} ( M \vec{c} - \vec{d} )$$

where
\vec{e}ₙ is a vector-valued auxiliary variable,
sₙ is a scalar increment of the iteration and
μ is a constant threshold value which ensures that the values of the colour channels l are very unequal everywhere.

In Equation (3), all mathematical operations act element-by-element on the vectors involved.

The increment sₙ, which may also be referred to as gradient increment of the n-th iteration, may be constant. Alternatively, a length of the increment sₙ may become shorter in each step of the iteration. Advantageously, the increment sₙ may also be adjusted adaptively. For example, the increment sₙ can be adaptively adjusted using a similarity measure, which measures the similarity between \vec{c}ₙ and \vec{c}ₙ₊₁, such that the length of the increment sₙ decreases monotonically as the similarity increases.

The solution \vec{c}=M^{MP}\vec{d} calculated using the Moore-Penrose inverse can be used as initial value \vec{c}₀, wherein the regularization parameter δ is non-zero here. \vec{c}₀ can be used as initial value for \vec{e}₀.

The spectral properties of the dyes can be influenced by the sample itself. This effect is referred to as solvatochromism. In such cases, the use of what are known as “blind unmixing” algorithms is preferable because the sample cannot be calibrated. For example, under the assumption that a multichannel fluorescence microscope image with a multiplicity of measured spectral channels and pixels contains at least one pixel with exactly one dye in each case, it is possible to use a simplex maximization algorithm in order to identify spectrally pure pixels. Spectrally pure pixels or “singly coloured pixels” are those pixels which contain exactly one dye, in which measurement intensity is therefore present only for one of the dyes. These spectrally pure pixels can then be regarded as an ex situ reference measurement and used for spectral unmixing. This method, known as N-FINDR, was used for the first time in the context of unmixing of synthetic aperture radar (SAR) hyperspectral images [1] but can also be used for blind spectral unmixing of fluorescence channels. N-FINDR is the basis for automatic component extraction (ACE) currently offered. A disadvantage of N-FINDR is that its basic assumption is not verified: In a generally stained sample, it is not clear whether certain pixels are spectrally pure. In addition to the problem of autocalibration of the unmixing, there is the problem of autofluorescence. As soon as a tissue section or cell cultures are stained, an autofluorescence spectrum, and hence light that does not originate from excited dyes, is superimposed on the spectrum of the given dye. This autofluorescence light distorts both ex situ reference measurements and the unmixing that was autocalibrated by way of ACE.

In a particularly preferred variant of the method according to the invention, a calibrated mixing matrix M^{cal} is formed from the mixing matrix M using measurement data \vec{d}, and the system of equations \vec{d}=M^{cal}\vec{c} is solved in order to ascertain \vec{c}.

To solve this system of equations, the methods described in detail above can be used with the proviso that the calibrated mixing matrix M^{cal} is used instead of the mixing matrix M.

The use of a calibrated mixing matrix M^{cal} offers advantages in respect of the following problems described here:
1) the time-consuming ex situ reference measurements,
2) the potentially non-existent single-coloured pixels in a multiplicity of spectral channels in automatic component extraction (ACE) and
3) the impairment of ex situ reference measurements and autocalibration due to superposition of autofluorescence.

Firstly, complicated ex situ reference measurements and sample preparations can be avoided when the calibrated mixing matrix M^{cal} is used. Furthermore, the calibrated mixing matrix M^{cal} allows a regularization of the unmixing matrix in the case of blind unmixing by a known mixing matrix. Finally, a digital calibration of the mixing matrix is not influenced by autofluorescence.

In a preferred variant of the method according to the invention, the following method steps are carried out to form the calibrated mixing matrix M^{cal}:
a) for each pixel, a similarity measure α is calculated between the measurement data \vec{d} for the relevant pixel and the individual columns of the mixing matrix M;
b) for each pixel, the column of the mixing matrix M for which the similarity measure α has the greatest value is determined;
c) for each column of the mixing matrix M, the pixels for which the similarity measure α of the measurement data obtained for the relevant pixel with the respective column is greater than a threshold value σ to be defined are selected;
d) for each column of the mixing matrix M, the measurement data \vec{d} of the pixels selected in step c) are averaged;
e) the calibrated mixing matrix M^{cal} is formed by virtue of
e1) the columns of the mixing matrix M for which at least one pixel has been selected in step c) are replaced by the values averaged in step d) for the relevant column; and
e2) the columns of the mixing matrix M for which no pixel has been selected in step c) are left unchanged.

The similarity measure α is expediently a positive-definite scalar function. For example, the similarity measure can be a regularized normalized inner product:

$$α ( {d}_{k} ; {M}_{l} ) = 〈 {d}_{k} \vert {M}_{l} 〉 / ( \sqrt{〈 {d}_{k} \vert {d}_{k} 〉 \cdot 〈 {M}_{l} \vert {M}_{l} 〉} + γ )$$

with the inner product [symbol] | [symbol] and a scalar regularization parameter γ. Mₗ denotes the l-th column of the mixing matrix M, i.e. a vector with k components, in this case.

Advantageous exemplary embodiments of the microscope according to the invention and advantageous variants of the method according to the invention are described below, in particular in association with the dependent claims and the figures, in which:

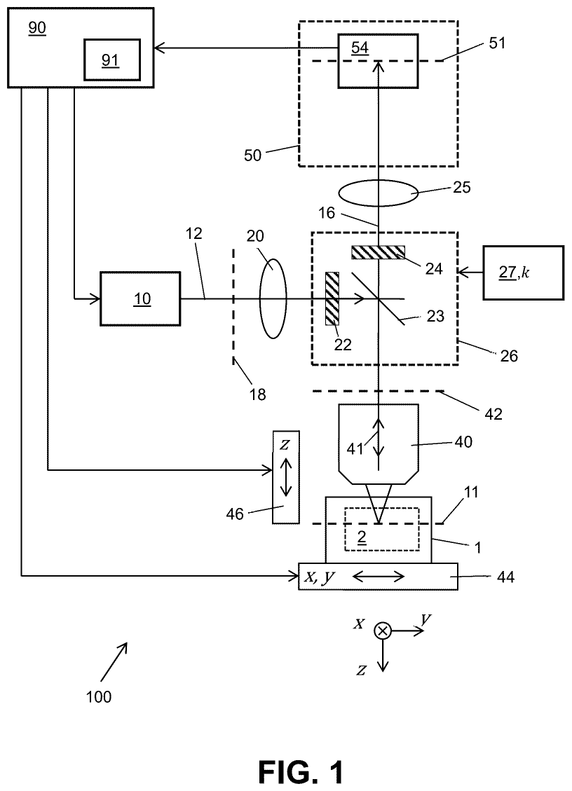

FIG. 1: shows a schematic illustration of a first exemplary embodiment of a microscope according to the invention; and

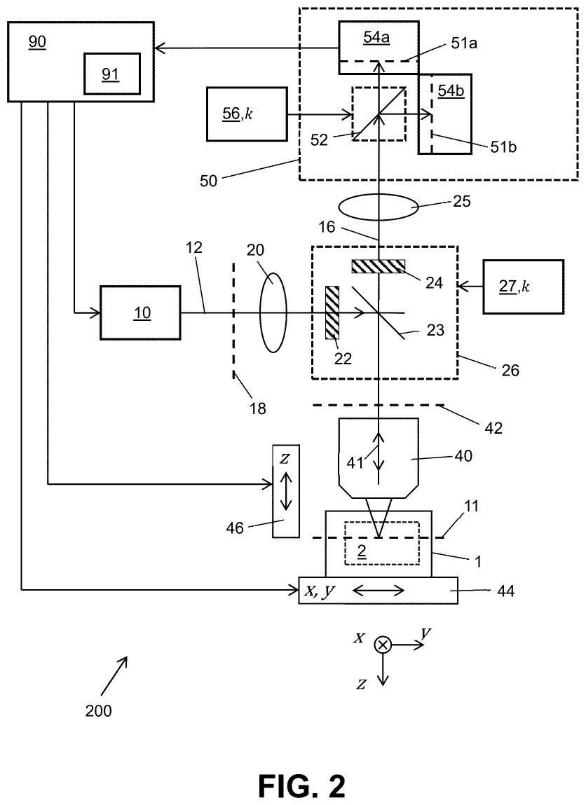

FIG. 2: shows a schematic illustration of a second exemplary embodiment of a microscope according to the invention.

Identical and identically acting components are generally provided with the same reference signs in the figures.

A first exemplary embodiment of a microscope 100 according to the invention will be described with reference to FIG. 1.

The microscope 100 firstly comprises an illumination beam path having a radiation source 10, e.g. a laser or a laser module, for emitting excitation light, wherein the illumination beam path is configured to direct or guide the excitation light into a sample region 1. In the example shown, the illumination beam path furthermore comprises a tube lens 20, an excitation filter 22, a main beam splitter 23 and a microscope objective 40. The excitation filter 22 is a transmission filter which passes only those spectral components of the excitation light 12 which are desired for the respective experiment. The tube lens 20 generates an intermediate image plane 18, i.e. a plane which is optically conjugate to a plane 11 in a sample 2 in the sample space 1. In the illumination beam path, the excitation light 12 passes through the intermediate image plane 18 and via the tube lens 20 and the excitation filter 22 to the main beam splitter 23 and is reflected there in the direction of the microscope objective 40. The excitation light 12 then passes through a back focal plane 42 of the microscope objective 40 and is subsequently directed from the microscope objective 40 into the sample space 1. The sample 2 can be a biological sample and is prepared with dyes which can be excited by the excitation light 12. The sample may also have intrinsically fluorescent proteins. The wavelength and intensity of the excitation light 12 can be chosen suitably with regard to the sample 2 and the dyes used and/or the proteins to be examined. The radiation source 10 can consist of a multiplicity of different lasers. The wavelength and/or intensity can be settable.

Furthermore, the microscope 100 comprises a detection beam path with the microscope objective 40 and a detector 54 for detecting emission light 16 emitted by the sample 2 in the sample region 1 as a consequence of being irradiated with the excitation light 12. The detection beam path is configured to direct the emission light 16 to the detector 54. In the example shown, the microscope 100 is a wide-field microscope and the detector 50 is a camera, i.e. a field of view (FOV) of the detection beam path is imaged onto a sensor plane 51 of the camera 50. The sensor plane 51 is optically conjugate to a plane 11 in the sample space 1. The emission light 16 emitted by the sample 2 can typically be red-shifted fluorescence emitted by the dyes in the sample 2. The main beam splitter 23 is configured such that it transmits the red-shifted emission light 16 and reflects the excitation light 12. This prevents large parts of the excitation light 12 scattered back from the sample space 1 from being able to pass in the direction of the camera 50. In the detection beam path, the emission light 16 emitted by the sample 2 is received by the microscope objective 40, passes through the main beam splitter 23 and an emission filter 24 and is then imaged by a tube lens 25 into the sensor plane 51 of the camera 50. The emission filter 24 is a transmission filter which passes only those spectral components of the emission light 16 which should be measured for the respective experiment.

In the exemplary embodiment shown, the excitation filter 22, the main beam splitter 23 and the emission filter 24 are arranged in an interchangeable filter cube or filter module 26. In the exemplary embodiment shown, there is a schematically illustrated changeover mechanism 27 which serves to introduce different filter cubes (not shown in the figure) which in each case have different excitation filters, main beam splitters and/or emission filters. For example, the changeover mechanism may comprise a linear slide, by means of which a respective desired filter cube 26 can be introduced into the beam path in a direction perpendicular to the plane of the drawing. Changing the filter cube in each case realizes a different system configuration k of the excitation beam path and of the detection beam path.

The general part of the description describes many other options as to how the different system configurations k of the excitation beam path and of the detection beam path, which are required for the invention, can be realized. For example, the light source 10 could also emit excitation light 12 with a different spectral composition for each of the system configurations k.

From among the components of excitation filter 22, main beam splitter 23 and emission filter 24, only the main beam splitter 23 is mandatory for directing the excitation light 12 in the direction of the sample 2. Consequently, the changeover mechanism 27 could also be a changeover mechanism serving only to introduce a different main beam splitter into the beam path in each case.

Furthermore, the microscope 100 in the example shown comprises a mechanical drive 44, in particular an automated mechanical drive, for setting a relative lateral position x, y between the sample 2 and the microscope objective 40 with respect to an optical axis 41 of the microscope objective 40 and a control unit 90, e.g. a PC, for evaluating the emission light 16 detected by the detector 54. In the example shown, the optical axis 41 of the microscope objective 40 extends in the direction of the z-axis. The mechanical drive 44 can be e.g. part of a motorized sample stage and, in the example shown, serves to set a predefined position of the sample 2, i.e. predefined x-, y-coordinates of the sample 2 with respect to the optical axis 41. A right-handed orthogonal coordinate system x, y, z is illustrated below the mechanical drive 44. In the example shown, the microscope 100 furthermore comprises an axial drive 46, which is used to set a predefined axial distance, i.e. a distance in the z-direction between the sample 2 and the microscope objective 40. The control unit 90 may be configured to control the mechanical drive 44 and/or the axial drive 46.

According to the invention, the control unit 90 comprises a memory device 91 in which, first of all, original excitation spectra χₗ(λ₁) and emission spectra ϵₗ(λ₂) of dyes l are stored. The original excitation spectra χₗ(λ₁) and/or the original emission spectra ϵₗ(λ₂) of at least one of the dyes l may be determined in advance by ex situ measurements, or they may be loaded from a database for at least one of the dyes l.

According to the invention, the memory device 91 also stores spectral properties Aₖ(λ₁) of the illumination beam path and spectral properties Dₖ(λ₂) of the detection beam path for the different system configurations k of the illumination beam path and of the detection beam path.

In the exemplary embodiment shown, the spectral properties Aₖ(λ₁) of the illumination beam path include at least the spectral properties of the light source 10, of the excitation filter 22, of the main beam splitter 23 and of the microscope objective 40.

The spectral properties Aₖ(λ₁) of the illumination beam path may also be referred to as a spectral signature Aₖ(λ₁) of the illumination beam path. The spectral signature Aₖ(λ₁) can be regarded as a scalar function which represents the spectral properties of the illumination beam path in the k-th system configuration.

In the exemplary embodiment shown, the spectral properties Dₖ(λ₂) of the detection beam path include at least the spectral properties of the microscope objective 40, of the main beam splitter 23 and of the emission filter 24.

The spectral properties Dₖ(λ₂) of the detection beam path may also be referred to as the spectral signature of the detection beam path. The spectral signature Dₖ(λ₂) can be regarded as a scalar function which represents the spectral properties of the detection beam path in the k-th system configuration.

According to the invention, the control unit 90 is configured to make use of the original excitation spectra χₗ(λ₁) and emission spectra ϵₗ(λ₂) of those dyes l with which the sample 2 is prepared, and furthermore make use of the spectral properties of the illumination beam path Aₖ(λ₁) and the spectral properties Dₖ(λ₂) of the detection beam path to ascertain values cₗ(x, y, z) proportional to concentrations of the respective dyes l at a location (x, y, z) in the sample 2 from measurement data dₖ(x, y, z) measured by the detector 54 for the relevant location (x, y, z) in the sample 2 for different system configurations k.

For this purpose, the method according to the invention or one of the variants of the method according to the invention described in the general part of the description can be carried out by the microscope 100.

Particularly preferably, the values cₗ(x, y, z) in each case proportional to the concentration of the various dyes l at the location (x, y, z) in the sample 2 are ascertained using the mixing matrix introduced in the general part of the description.

$${M}_{k , l} = \int {A}_{k} ( {λ}_{1} ) \cdot {χ}_{l} ( {λ}_{1} ) d {λ}_{1} \cdot \int {D}_{k} ( {λ}_{2} ) \cdot {ϵ}_{l} ( {λ}_{2} ) d {λ}_{2}$$

For example, in order to ascertain the values cₗ(x, y, z) in each case proportional to the concentration of the various dyes l at the location (x, y, z) in the sample 2, the system of equations given by

$${d}_{k} ( x , y , z ) = {\sum }_{l = 1}^{L} {M}_{k , l} {c}_{l} ( x , y , z )$$

can be solved. Using the nomenclature introduced in the general part of the description, this system of equations can also be written vector form as \vec{d}=M\vec{c}. Variants of how this can be carried out, for example using a Moore-Penrose inverse M^{MP} of the mixing matrix M and using iterative methods, have been explained in the general part of the description.

In preferred variant of the invention, a calibrated mixing matrix M^{cal} is formed from the mixing matrix M using measurement data \vec{d}. Examples of how this can be carried out have been explained in the general part of the description. To ascertain the values cₗ(x, y, z) in each case proportional to the concentration of the various dyes l at the location (x, y, z) in the sample 2, it is possible to use the calibrated mixing matrix M^{cal} rather than the original mixing matrix M. For example, the system of equations given by

$$\vec{d} = {M}^{cal} \vec{c}$$

can be solved. To this end, use can be made of methods which have been described in the general part of the description as regards the solution of the system of equations \vec{d}=M\vec{c}.

The second exemplary embodiment of a microscope 200 according to the invention shown in FIG. 2 only differs from the first exemplary embodiment in FIG. 1 in the region of the detector. Only the components of the microscope 200 that differ in comparison with the microscope 100 are explained here.

In the microscope 200, the detection beam path comprises a detection unit 50 with a colour splitter 52 for splitting the emission light into two spectrally different channels a, b. The first channel a comprises a first detector 54a with a first detection plane 51a. The second channel b comprises a second detector 54b with a second detection plane 51b. The detection planes 51a, 51b are each situated in planes optically conjugate to the plane 11 in the sample 2. Further colour splitters, which can be introduced selectively into the detection beam path in place of the colour splitter 52, are not shown in FIG. 2. In this exemplary embodiment, the detector present according to the invention is realized by the two detectors 54a and 54b.

Moreover, a changeover mechanism 56 is present, for example a linear slide, by means of which one of the colour splitters can be introduced into the detection beam path in each case. The system configuration k is modified by replacing the colour splitter 52 with another colour splitter with different spectral properties; i.e. the spectral properties of the colour splitter 52 situated in the detection beam path in each case are also included in the spectral signature Dₖ(λ₂), which represents the spectral properties of the detection beam path in the k-th system configuration.

The present invention presents a novel microscope and a novel method in which the disadvantages of the methods used for unmixing emission signals, in particular the high time expenditure and the less reliable results, as explained in the introduction, can be at least partially avoided.

In exemplary embodiments of the invention, spectral signatures are calculated using the specifications of the spectral properties of the hardware installed in a microscope system (e.g. light sources, filters, beam splitters, glasses, detectors, gratings, prisms). By making use of dyes whose data a user inputs into the software and whose emission spectra the software is capable of ascertaining from an internal or external database, it is subsequently possible to ascertain, for all given markers of different colour, the specific spectral signature in the user-selected acquisition setting, i.e. in the system configuration k present in each case, for the examined sample from the mathematical superposition of an emission spectrum with the spectral data of the employed hardware. These spectral signatures, ascertained in the background when the dyes used are specified, can be used directly during or after the acquisition for the unmixing of the colour signals.

### LIST OF REFERENCE SIGNS

1 Sample region
1 Vector whose components all have the value of 1
2 Sample
10 Radiation source, light source, e.g. laser or LED source
12 Illumination radiation, illumination light, excitation light
16 Emission radiation or emission light emitted by sample 2 in sample region 1
20 Lens in the excitation beam path
22 Excitation filter
23 Main beam splitter
24 Emission filter
25 Lens in the detection beam path
26 Filter cube
27 Changeover mechanism for filter cube 26
40 Microscope objective
41 Optical axis of the microscope objective 40
44 Mechanical drive, xy-displacement stage
46 Mechanical drive, z-drive
50 Detection unit
51 Detection plane, optically conjugate to the sample plane 11
51a Detection plane, optically conjugate to the sample plane 11
51b Detection plane, optically conjugate to the sample plane 11
54 Detector, camera
54a Detector, camera
54b Detector, camera
56 Colour splitter in the detection beam path
57 Changeover mechanism for colour splitter 52
90 Control unit
91 Memory device
100 Microscope according to the invention
Aₖ(λ₁) Scalar function representing the spectral properties of the illumination beam path in the k-th system configuration, spectral signature
\vec{c} Vector \vec{c} containing the sought values cₗ(x, y, z) with l=1, . . . , L as components
\vec{c}₀ Initial value for \vec{c}
\vec{c}ₙ n-th value for \vec{c}
\vec{c}ₙ₊₁ n+1-th value for \vec{c}
cₗ(x, y, z) Sought value proportional to the concentration of the dye l at the location (x, y, z) in the sample 2
\vec{d} Vector containing the measurement data dₖ(x, y, z) with k=1, . . . , K measured by the detector for a location (x, y, z) in the sample in the k-th system configuration as components
dₖ(x, y, z)=dₖ Measurement data measured by the detector 54 in the k-th system configurations for a location (x, y, z) in the sample 2
Dₖ(λ₂) Scalar function representing the spectral properties of the detection beam path in the k-th system configuration, spectral signature
[symbol] dₖ(x, y, z)|Mₗ [symbol] Inner product of dₖ(x, y, z) and Mi
\vec{e} Vector-valued auxiliary variable,
\vec{e}₀ Initial value for \vec{e}
\vec{e}ₙ n-th value for \vec{e}
\vec{e}ₙ₊₁ n+1-th value for \vec{e}
I Unit matrix
k Integer index that identifies the different system configurations with which measurements are carried out; line index of the mixing matrix M
K Number of different system configurations with which measurements are carried out, number of rows of the mixing matrix M
l Integer index that identifies the various dyes with which the sample 2 is prepared; column index of the mixing matrix M
L Number of different utilized dyes with which the sample 2 has been prepared; number of columns of the mixing matrix M
M Mixing matrix
max(a, b) Maximum of a and b
M⁻¹ Inverse of matrix M
M^{cal} Calibrated mixing matrix
M^{MP} Moore-Penrose inverse of the mixing matrix M
M^{T} Transpose of the matrix M
s Scalar increment of the iteration
sign (f) Sign of f
s₀ Initial value for s
sₙ n-th value for s
sₙ₊₁ n+1-th value for s
x, y, z Location in the sample 2
α(dₖ; Mₗ) Scalar and positive definite measure of the similarity between the measurement data for a pixel dₖ(x, y, z) and the column Mₗ of the mixing matrix M
γ Scalar regularization parameter
δ Scalar regularization parameter
ϵₗ(λ₂) Original emission spectrum of the l-th fluorescent dye as a function of the wavelength λ₂ of the emission light 16
λ₁ Wavelength of the excitation light 12 in the excitation beam path
λ₂ Wavelength of the emission light 16 in the detection beam path
μ Scalar threshold
σ Scalar threshold
χₗ(λ₁) Original excitation spectrum of the l-th fluorescent dye as a function of the wavelength λ₁ of the excitation light 12

### REFERENCES

[1] Winter, Michael E.: “N-FINDR: An algorithm for fast autonomous spectral end-member determination in hyperspectral data.” Imaging spectrometry V. Vol. 3753. SPIE, 1999

1. A Microscope comprising:
an illumination beam path with a radiation source for emitting excitation light, the illumination beam path being configured to guide the excitation light into a sample region,
a detection beam path with a microscope objective and with a detector for detecting emission light emitted by a sample in the sample region as a consequence of being irradiated by the excitation light, the detection beam path being configured to guide the emission light to the detector, and
a control unit for evaluating the emission light detected by the detector,
the control unit having a memory device in which original excitation spectra and emission spectra of dyes and, for different system configurations of the illumination beam path and of the detection beam path,
spectral properties of the illumination beam path and
spectral properties of the detection beam path are stored,
wherein the control unit is configured to make use of
the original excitation spectra and emission spectra of those dyes with which the sample is prepared,
the spectral properties of the illumination beam path and the spectral properties of the detection beam path to ascertain values proportional to concentrations of the respective dyes at a location in the sample from measurement data measured by the detector for the relevant location in the sample for different system configurations.

2. The Microscope according to claim 1,
wherein the spectral properties of the illumination beam path contain at least the spectral properties of the light source.

3. The Microscope according to claim 2,
wherein the spectral properties of the illumination beam path additionally contain the spectral properties of at least one of the following components: excitation filters, lenses, mirrors, beam splitters, main beam splitters, microscope objective.

4. The Microscope according to claim 1,
wherein the spectral properties of the detection beam path contain at least the spectral properties of the detector and of the microscope objective.

5. The Microscope according to claim 4,
wherein the spectral properties of the detection beam path additionally contain the spectral properties of at least one of the following components: beam splitters, main beam splitters, lenses, mirrors, emission filters, dispersive device in the detection beam path.

6. A Microscopy method, wherein
a) excitation light emitted by a radiation source is guided into a sample region via an illumination beam path,
b) emission light emitted by a sample in the sample region as a consequence of being irradiated by the excitation light is guided to a detector via a detection beam path comprising a microscope objective,
c) the emission light for different locations in the sample is measured by the detector in each case for different system configurations of the illumination beam path and of the detection beam path,
wherein using original excitation spectra and emission spectra of dyes with which the sample is prepared and using
spectral properties of the illumination beam path and
spectral properties of the detection beam path
in the respective different system configurations,
values proportional to concentrations of the respective dyes at a location in the sample are ascertained from measurement data measured by the detector for the relevant location in the sample in the different system configurations.

7. The Method according to claim 6,
wherein the original excitation spectra and/or the original emission spectral of at least one of the dyes are determined in advance by ex situ measurements.

8. The Method according to claim 6,
wherein the original excitation spectra and/or the original emission spectral of at least one of the dyes are loaded from a database.

9. The Method according to claim 6,
wherein a mixing matrix M_{k,l}=∫Aₖ(λ₁)·χₗ(λ₁)dλ₁·∫Dₖ(λ₂)·ϵₗ(λ₂)dλ₂ is calculated, where
k is an index that denotes the system configurations with which measurements were made,
l is an index that denotes the various dyes,
Aₖ(λ₁) represents the spectral properties of the illumination beam path in the k-th system configuration,
λ₁ is the wavelength of the excitation light in the excitation beam path,
χₗ(λ₁) is the original excitation spectrum of the l-th dye,
Dₖ(λ₂) represents the spectral properties of the detection beam path in the k-th system configuration,
λ₂ is the wavelength of the emission light in the detection beam path,
ϵₗ(λ₂) is the original excitation spectrum of the l-th dye,
and wherein the values cₗ(x, y, z) in each case proportional to the concentration of the various dyes l at the location in the sample are ascertained using the mixing matrix M_{k,l}.

10. The Method according to claim 9,
wherein in order to ascertain the values c₁(x, y, z) in each case proportional to the concentration of the various dyes l at the location in the sample, the system of equations given by \vec{d}=M\vec{c} is solved, where
\vec{d} is a vector which contains the measurement data dₖ(x, y, z), k=1, . . . , K, measured by the detector in the k-th system configuration for a location in the sample, as components,
\vec{c} is the vector given by the sought values c₁(x, y, z), l=1, . . . , L and
M is the mixing matrix M_{k,l}, l=1, . . . , L.

11. The Method according to claim 6,
wherein the number of different system configurations in which measurements are carried out is greater than or equal to the number of different dyes.

12. The Method according to claim 9,
wherein a Moore-Penrose inverse M^{MP} of the mixing matrix M is calculated as
$${M}^{MP} = {( {M}^{T} M + δ I )}^{- 1} {M}^{T}$$
where
M^{T} is the transpose of the matrix M,
I is the unit matrix,
δ is a scalar regularization parameter and
(M^{T}M+δI)⁻¹ is the inverse matrix of M^{T} M+δI and
in that \vec{c} is calculated as \vec{c}=M^{MP}\vec{d}.

13. The Method according to claim 9,
wherein \vec{c} is determined iteratively, wherein
the n+1-th value \vec{c}ₙ₊₁ is in each case calculated from the n-th value \vec{c}, by
$${\vec{c}}_{n + 1} = ( [ {\vec{c}}_{n} ] / [ {M}^{T} \cdot 1 ] ) ∘ ( {M}^{T} ( [ \vec{d} ] / [ M \cdot {\vec{c}}_{n} ] ) ) ,$$
where
M^{T} is the transpose of the matrix M,
1 is a vector whose components all have the value of 1,
the square brackets each denote element-by-element division and
⋅ denotes element-by-element multiplication.

14. The Method according to claim 13,
wherein, for an initial value \vec{c}₀, the Moore-Penrose inverse M^{MP} is used to calculate the following solution:
$$\vec{c} = {M}^{MP} \vec{d} \underline{.}$$

15. The Method according to claim 6,
wherein the values proportional to the concentrations of the respective dyes at a location in the sample are ascertained under the assumption that values of the colour channels are very unequal everywhere.

16. The Method according to claim 9,
wherein \vec{c} is determined iteratively, wherein
the n+1-th value \vec{c}ₙ₊₁ is in each case calculated from the n-th value \vec{c}ₙ by
$${\vec{c}}_{n + 1} = sign ( {\vec{e}}_{n + 1} ) \cdot max ( \vert {\vec{e}}_{n + 1} \vert - μ , 0 ) ,$$
$$where$$
$${\vec{e}}_{n + 1} = {\vec{e}}_{n} - {s}_{n} \cdot {M}^{T} ( M \vec{c} - \vec{d} ) ,$$
where
\vec{e}ₙ is a vector-valued auxiliary variable,
sₙ is a scalar increment of the iteration and
μ is a constant threshold value.

17. The Method according to claim 16,
wherein the increment sₙ is adaptively adjusted using a similarity measure, which measures the similarity between \vec{c}ₙ and \vec{c}ₙ₋₁, such that the length of the increment sₙ decreases monotonically as the similarity increases.

18. The Method according to claim 16,
wherein, for the initial value \vec{c}₀,
the solution \vec{c}=M^{MP}\vec{d} calculated using the Moore-Penrose inverse M^{MP}=(M^{T}M+δI)⁻¹M^{T} is used, wherein \vec{c}₀ is used as the initial value for \vec{e}₀.

19. The Method according to claim 9,
wherein a calibrated mixing matrix M^{cal} is formed from the mixing matrix
M using measurement data \vec{d} and in that subsequently
in order to ascertain the values \vec{c} in each case proportional to the concentration of the dyes l at the location (x, y, z) in the sample, the system of equations given by \vec{d}=M^{cal}\vec{c} is solved.

20. The Method according to claim 19,
wherein
the following method steps are carried out for forming the calibrated mixing matrix M^{cal}:
a) for each pixel, a similarity measure α is calculated between the measurement data \vec{d} for the relevant pixel and the individual columns of the mixing matrix M;
b) for each pixel, the column of the mixing matrix M for which the similarity measure α has the greatest value is determined;
c) for each column of the mixing matrix M, the pixels for which the similarity measure of the measurement data obtained for the relevant pixel with the respective column is greater than a threshold value σ to be defined are selected;
d) for each column of the mixing matrix M, the measurement data \vec{d} of the pixels selected in step c) are averaged;
e) the calibrated mixing matrix M^{cal} is formed by virtue of
e1) the columns of the mixing matrix M for which at least one pixel has been selected in step c) are replaced by the values averaged in step d) for the relevant column; and
e2) the columns of the mixing matrix M for which no pixel has been selected in step c) are left unchanged.

21. The Method according to claim 20,
wherein the similarity measure is a regularized normalized inner product.

22. The Method according to claim 14,
wherein the regularization parameter δ is equal to zero.

23. The Method according to claim 18,
wherein the regularization parameter δ is not equal to zero.
